(19) United States
(12) Patent Application Publication
(10) Pub. No.: US 2018/0330831 A1
(43) Pub. Date: Nov. 15, 2018

(54) EXOTHERMIC REACTION ANALYSIS BY PRE-REACTION SAMPLE RETENTION

(71) Applicant: IH IP HOLDINGS LIMITED, St. Helier (JE)

(72) Inventors: Darren R. Burgess, Charlotte, NC (US); Michael Raymond Greenwald, Indian Trail, NC (US); Brent W. Barbee, Stanfield, NC (US)

(21) Appl. No.: 15/778,040

(22) PCT Filed: Dec. 22, 2016
(86) PCT No.: PCT/US16/68229

§ 371 Date: May 22, 2018

Related U.S. Application Data
(60) Provisional application No. 62/259,537, filed on Nov. 24, 2015.

(51) Int. Cl. G21B 3/00

(52) U.S. Cl. CPC G21B 3/00

(57) ABSTRACT

Reaction processes occurring within an exothermic reaction reactor are investigated by comparing changes to at least one material in the reaction to a non-reacted sample of the material. Prior to the reaction, a sample or “coupon” of the material is removed and retained. The coupon of material is withheld from the reactor. The material is placed in the reactor and at least one exothermic reaction is triggered and sustained. Following the exothermic reaction, the material is removed from the reactor. Both the material and the coupon are then analyzed to ascertain changes to the material that did not occur to the sample. These changes are indicative of processes that occurred in the reactor.

### CROSS-REFERENCED TO RELATED APPLICATIONS

This application is a U.S. National Stage application of International Application No. PCT/US16/68229, filed on Dec. 22, 2016, which claims the benefit of U.S. Provisional Patent Application No. 62/259,537, filed on Nov. 24, 2015, the entire contents of which are all hereby incorporated herein by reference.

### FIELD OF INVENTION

The present invention relates generally to exothermic reactions, and in particular to a system and method of preserving a sample of a pre-reaction material to investigate excess heat generation processes.

### BACKGROUND

In the face of global climate change, nuclear fusion, the energy source that powers the Sun and stars, is an attractive alternative to fossil fuels. The fuel (deuterium) used in nuclear fusion may be extracted from sea water, and nuclear fusion produces neither greenhouse gases nor long-lived radioactive waste. Nuclear fusion normally only occurs at extremely high temperatures (millions of degrees), such as found in stars and very large reactors. Research is ongoing to produce nuclear fusion in tokamak reactors, in which magnetic fields confine and heat a plasma in a toroidal shape, and inertial confinement reactors, in which pressure and heat are applied to fuel pellets by high-powered lasers.

Since the 1990s, a small community of researchers worldwide has been conducting independent research into anomalous heat generation reactions. Over 150 peer-reviewed papers have reported the generation of excess or anomalous heat (i.e., greater heat output than energy input) in various experiments. Recently, interest in anomalous exothermic reactions has increased, especially in the Low Energy Nuclear Reaction (LENR) area, with universities, national laborites (Italy's ENEA; US Naval Research Lab), NASA, and corporations such as Mitsubishi and Toyota conducting LENR experiments.

The phenomenon of anomalous heat generation is in the research phase. Much is still not known about the precise chemical and nuclear reactions occurring within the reactor. Hence, at least two avenues of inquiry are of interest: how to generate heat (i.e., the development of economically practical excess heat generation reactors and concomitant energy generation systems), and what exothermic reactions entail (i.e., understanding the physics of various exothermic reaction processes). These avenues of inquiry are complimentary and synergistic. In particular, a greater understanding of the physical, chemical and/or nuclear processes occurring in these anomalous heat generation reactions will enhance and speed the development of practical, green energy sources.

The Background section of this document is provided to place embodiments of the present invention in technological and operational context and to assist those of skill in the art in understanding their scope and utility. Approaches described in the Background section could be pursued, but are not necessarily approaches that have been previously conceived or pursued. Unless explicitly identified as such, no statement herein is admitted to be prior art merely by its inclusion in the Background section.

### SUMMARY

The following presents a simplified summary of the disclosure in order to provide a basic understanding to those of skill in the art. This summary is not an extensive overview of the disclosure and is not intended to identify key/critical elements of embodiments of the invention or to delineate the scope of the invention. The sole purpose of this summary is to present some concepts disclosed herein in a simplified form as a prelude to the more detailed description that is presented later.

According to one or more embodiments described and claimed herein, reaction processes occurring within an exothermic reaction reactor are investigated by comparing changes to at least one material involved in the reaction to a non-reacted sample of the material. Prior to the reaction, a sample or “coupon” of the material is removed and retained. The coupon of material is withheld from the reactor. At least one process takes place in the reactor. Following the process, the material is removed from the reactor. Both the material and the coupon are then analyzed to ascertain changes that have occurred to the material. These changes are indicative of processes that occurred in the reactor.

Two types of reactors may be explicitly described in this disclosure. They are dry cell reactor and wet cell reactor. Examples of dry cell reactor include solid state reactors and plasma reactors, while examples of wet cell reactor include electrolytic cells. A solid state reactor contains hydrogen or deuterium that is in a solid form and is then released as a gas upon heating. A plasma reactor contains hydrogen or deuterium gas and has a voltage applied across electrodes to create a plasma of ionic species. An electrolytic reactor contains electrodes that are submerged in a solution and have a voltage applied across in order to induce the flow of current through the solution.

In some embodiments, for example, in a dry cell reactor, a coupon is first placed on the interior wall of the reactor before a reaction material is coated on the interior wall of the reactor. The coupon is then removed and retained. In other embodiments, for example, in a wet cell reactor, a portion of the material is retained before the material is placed inside the reactor. Yet in another embodiment, for example, in a plasma reactor or a wet cell reactor, a portion of the electrode on which the material is plated may be removed and retained for post-reaction analysis and comparison.

One embodiment relates to a method of investigating reaction processes within a heat generation reactor. A material prepared for use in the reactor is obtained. A sample of the material is removed. The material is placed in the reactor, while the sample is withheld from the reactor. At least one exothermic reaction is triggered and sustained. After the reaction, the material is removed from the reactor. One or more properties of the material removed from the reactor and those of the sample withheld from the reactor are analyzed. The results of the analysis are compared, for example, to identify one or more reactions that have taken place inside the reactor. The results of the analysis can also provide information on the properties, e.g., thermal, chemical, and material characteristics, of the reactions that have taken place inside the reactor.

### BRIEF DESCRIPTION OF THE DRAWINGS

The present invention will now be described more fully hereinafter with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

FIG. 1 is a sectional diagram of a dry cell reactor.

FIG. 2 is a sectional diagram of a wet cell reactor.

FIG. 3 is a flow chart illustrating an exemplary process of retaining a pre-reaction sample for comparison with post-reaction materials.

FIG. 4 is a flow chart illustrating another exemplary process of retaining a coupon of pre-reaction material for comparison with post-reaction materials.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

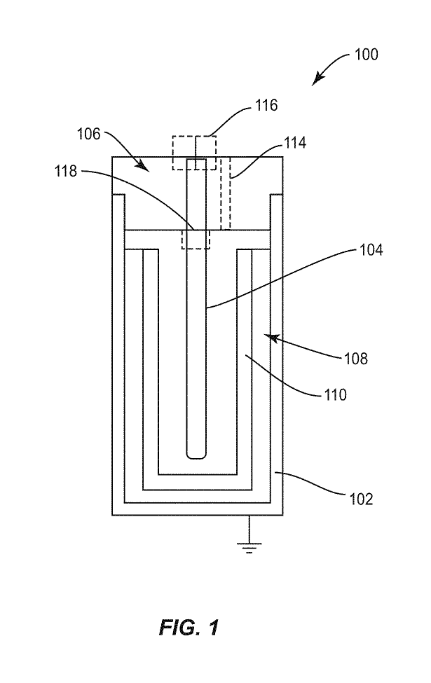

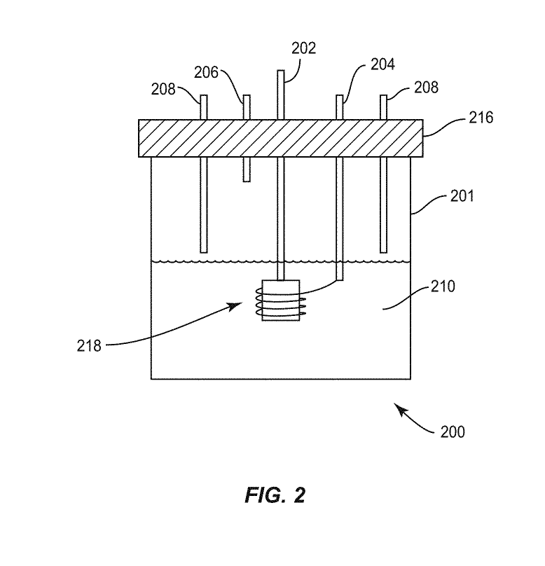

In a typical dry cell exothermic reaction, hydrogen gas is introduced by high pressure, or cycles of high and low pressure over a period of time (e.g., days). At some point, the hydrogen loading reaches a critical point, and a fusion reaction is triggered as the Coulomb barrier between two hydrogen or deuterium nuclei is overcome. These reactions often generate excess or anomalous heat—that is, greater heat output than the energy input into the reactor. In this disclosure, hydrogen may refer to one of the three hydrogen isotopes (protium, deuterium, and tritium) or a mix of two or more of the three hydrogen isotopes. A dry cell reactor is depicted in FIG. 1. Alternatively, a heat generation reactor can be designed as a wet cell, as depicted in FIG. 2.

In FIG. 1, an exemplary dry cell reactor 100 comprises a metal container 102, an electrode 104, and a lid 106. The metal container 102 is made of non-hydrogen-reactive material and is plated with gold 108, which in turn is plated with a deuterium absorbing material 110. The lid 106 provides accommodation for voltage controlling devices 116 and pressure controlling devices 114. During operation, hydrogen gas is introduced into the dry cell reactor 100 and is absorbed by the hydrogen absorbing material 110. It is again noted that in this disclosure, hydrogen gas refers to a gas that comprises one or more hydrogen isotopes (protium, deuterium, and tritium).

In FIG. 2, an exemplary wet cell reactor 200 comprises a container 201 holding a solution 210 of heavy water plus Lithium Deuteroxide (LiOD). The container 201 is covered by a Teflon lid 216. The Teflon lid 216 is configured to accommodate an anode 204, a cathode 202, two thermocouples 208, and a vent 206. In some embodiments, on the cathode 202, an anode coil 218 is wrapped around one end of the cathode 202. In some embodiments, a transition metal may be coated on the anode 204 and/or the anode coil 208. In one embodiment, the anode coil 218 is made of palladium. In one embodiment, the anode coil 218 is made of platinum.

The materials placed in a reactor may be inspected, both before and after the reaction process occurs, to ascertain changes in the surface topography, atomic arrangement, crystal structure, the presence of trace species, or the like. The ascertained changes may provide clues as to the precise processes that occurred in the reactor. However, inspection of reaction materials affixed to or plated on the interior wall of the reactor may be difficult. As an example, surface topography of a pre-reaction material may be an important factor in triggering anomalous heat generation. Surface topography of a post-reaction material may provide important information about the reaction. Comparing the pre-reaction surface topography and the post-reaction surface topography of a reaction material may help studying what have contributed to the anomalous heat generation and what have changed as a result of atomic rearrangement.

According to embodiments of the present invention, a material is prepared for use in a heat generation reactor (alternatively referred to as an exothermic reactor). In the present disclosure, a material may refer to a transition metal, an alloy, or a chemical compound. The material may be coated or plated or simply affixed to an interior section of the reactor by various means, including deposition (physical vapor deposition, chemical vapor deposition, sputtering, etc.), precipitation, and sectioning of a bulk material. In one embodiment, a sample, or “coupon,” of the material may be removed prior to placing the material in the reactor. In another embodiment, a coupon coated with the material may be removed from the reactor if the material is plated or affixed onto an interior section of the reactor. Herein a coupon refers to a structure used for holding a sample of the reaction material. In some embodiments, a coupon may be made of a material that does not react with the reaction material under the general conditions inside a heat generation reactor. For example, the coupon may be made of gold or silver, which does not react with palladium, nickel, lanthanum, etc., the transition metals that have a large hydrogen-absorbing capacity. Certain transition metals are known as good hydrogen storage materials and can achieve a loading ratio of hydrogen to metal atoms higher than 0.5. In some embodiments, palladium can achieve a hydrogen loading ratio of 0.8 to 1.0 under favorable pressure and temperature. Transition metals that can be used as hydrogen storage are often chosen as reaction materials in certain types of exothermic reactions, e.g., low energy nuclear reactions. The sample is withheld from the reactor. The rest of the material stays in the reactor, and goes through one or more exothermic reactions induced inside the reactor. After the reactions are complete, the resultant material is removed from the reactor and analyzed. The sample that was withheld prior to the reaction is also analyzed, and the results of the analyses are compared. This comparison may more clearly reveal changes in the material that resulted from the exothermic reactions. Additionally, the comparison may be important to ascertain that certain processes did or did not occur in a particular experiment. Examples of analysis of the material and sample that may be performed include surface and bulk analysis by techniques such as atomic force microscopy, scanning electron microscopy, scanning tunneling electron microscopy, X-ray photoelectron spectroscopy, and X-ray diffraction.

In one embodiment, gold foil is coated with a thin film of platinum by sputter deposition. The length and width of the coated foil are larger, by 2 to 20 cm, than the dimensions required for the reactor. A coupon of the excess material is cut off and retained for analysis. The remaining material is placed in a reactor and processed during the one or more reactions triggered inside the reactor. Data obtained from the reactor may suggest that certain reactions, e.g., an exothermic reaction, occurred. The processed material is removed from the reactor. Some portion of the processed material and the retained coupon are analyzed by Atomic Force Microscopy. The surface topographies of each sample represented in the respective, resulting micrographs are compared. Differences in the surface topography of the reactor material, as compared to the coupon, may provide useful information about how the material was changed by the reactions.

In another embodiment, a multi-step process is used to precipitate several grams of silver particles from silver nitrate. One to 20 grams of silver particles are retained for analysis. The remaining particles are coated or otherwise placed inside a reactor and processed. Data obtained from the reactor suggest that a reaction, e.g., an exothermic reaction occurred. The processed particles are removed from the reactor. Some portion of the processed particles and the retained grams of silver particles are both analyzed by X-ray Photoelectron Spectroscopy. The spectra are compared for any indications of new elements in the processed particles, not found in the retained particles. Any new element appeared in the processed material may indicate the reaction that took place inside the reactor is a nuclear reaction.

In another embodiment, palladium is deposited on aluminum oxide particles by chemical vapor deposition. One to 20 grams of the resulting particles are retained for analysis. The remaining particles are deposited or otherwise placed in a reactor and processed. Data obtained from the reactor suggest that no excess heat was generated. The processed particles are removed from the reactor. Some portion of the processed particles and the retained sample of silver particles are analyzed by X-ray Diffraction Spectroscopy. The two spectra are compared for indications of differences in crystal lattice size between the processed particles and the retained particles, which may indicate the degree of hydrogen loading in the processed particles.

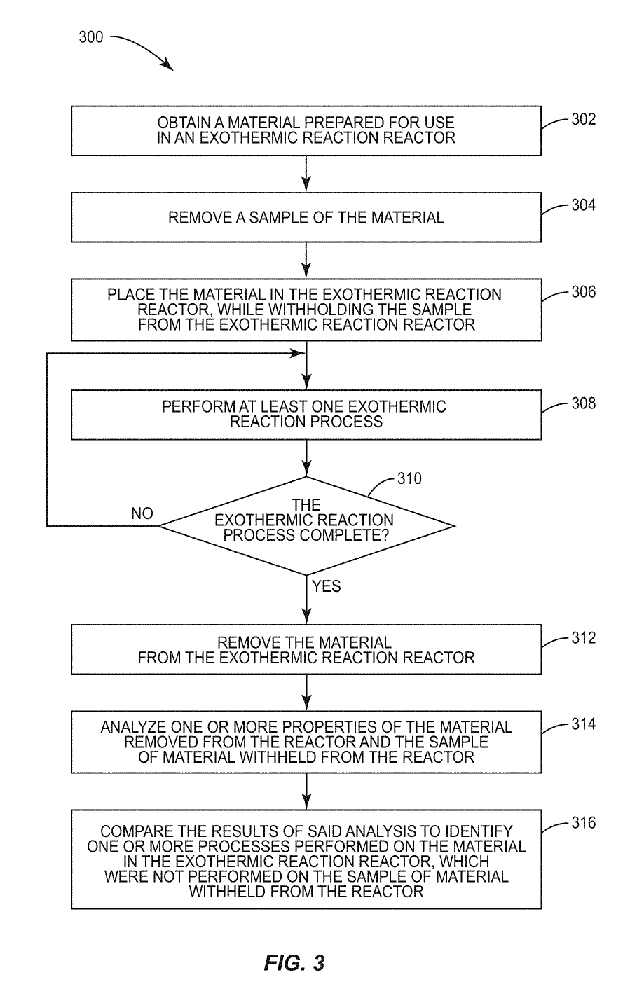

FIG. 3 depicts a method 300 of investigating reaction processes within a reactor. A material prepared for use in the reactor is obtained (block 302), and a sample of the material is removed (block 304). While the sample is withheld from the reactor, the rest of the material remains in the interior of the reactor to be processed during one or more reactions (block 306). One or more exothermic reactions are triggered and sustained (block 308). When all reactions are complete (block 310), the material is removed from the reactor (block 312). One or more properties of both the material retained inside the reactor and the sample withheld from the reactor are analyzed (block 314). These analyses are compared to identify one or more reactions that have taken place inside reactor, which did not occur to the sample of material withheld from the reactor (block 316).

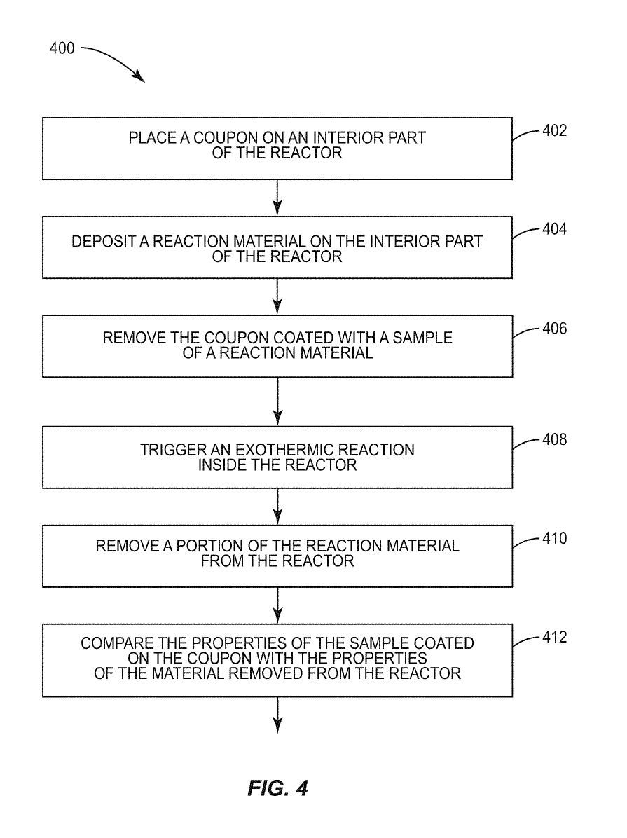

FIG. 4 illustrates another method 400 of investigating the reaction processes that have taken place within a reactor. A coupon is placed on an interior wall of the reactor (block 402). A reaction material is then deposited on the interior wall of the reactor (block 404). The coupon coated with a sample of the reaction material is removed from the reactor (block 406). An exothermic reaction is triggered inside the reactor (block 408). After the reaction, a portion of the reaction material is removed from the reactor (block 410). The properties of the sample coated on the coupon are compared with the properties of the material removed from the reactor (block 412).

In some embodiments, rather than retaining a sample of material that does not enter the reactor or removing a sample of material from the reactor, a portion of the material placed in the reactor is masked. For example, a suitable polymer having a high melting point and good chemical stability could be melted and solidified over a small portion of the material. The polymer is minimally affected by the reactions inside the reactor and shields the material that is being masked. Following a reaction process, the processed material is extracted from the reactor, and the polymer is etched away. Both the exposed portion of the material, and a portion of the material that was processed in the reactor, are then analyzed and compared. Differences may indicate whether and what type of exothermic reactions, e.g., a low energy nuclear reaction, occurred, and what changes have taken place.

Although, in the illustrative embodiments above, specific forms of analysis were specified for specific materials, in general, the material undergoing an exothermic process, and its non-reacted sample, may undergo a broad array of analyses, to investigate changes in as many properties of the materials as practical.

The methods, processes, and apparatus disclosed herein may, of course, be carried out or implemented in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of investigating an exothermic reaction process within a reactor, comprising:
placing a coupon on an interior part of the reactor;
depositing a reaction material on the interior part of the reactor;
removing the coupon coated with a sample of the reaction material;
triggering an exothermic reaction inside the reactor;
after the exothermic reaction, removing a portion of the reaction material from the reactor; and
comparing one or more properties of the sample coated on the coupon with the one or more properties of the material removed from the reactor.

2. The method of claim 1 wherein the one or more properties of the material removed from the reactor and the sample coated on the coupon are analyzed using one or more of atomic force microscopy, scanning electron microscopy, scanning tunneling electron microscopy, X-ray tunneling electron microscopy, X-ray photoelectron spectroscopy, and X-ray diffraction.

3. The method of claim 1 wherein the reaction material comprises gold foil coated with platinum by sputter deposition.

4. The method of claim 1 wherein the reaction material comprises silver nitrate particles precipitated from silver nitrate.

5. The method of claim 1 wherein the reaction material comprises aluminum oxide particles coated with palladium by chemical vapor deposition.

6. The method of claim 1 wherein the reactor comprises a wet cell reactor, the coupon is placed on an electrode of the wet cell reactor, and the coupon is coated with the reaction material when the reaction material is plated on the electrode.

7. The method of claim 1 wherein the reactor comprises a dry cell reactor, the coupon is placed on an interior wall of the dry cell reactor, and the coupon is coated with the reaction material when the reaction material is placed on the interior wall of the dry cell reactor.

8. The method of claim 1 wherein depositing the reaction material on the interior wall of the reactor comprises plating the reaction material on the interior wall of the reactor.

9. The method of claim 1 wherein the coupon is made of a material that does not interact with the reaction material under conditions inside the reactor.

10. The method of claim 9 wherein the coupon is made of gold.

11. A method of investigating reaction processes within an exothermic reactor, comprising:
placing a first material prepared for use in an exothermic reactor;
masking a first portion of the first material with a second material;
performing at least one exothermic reaction process;
after the exothermic reaction process, removing the second material from the first material;
analyzing one or more properties of the first material at both a position that was masked and a position that was not masked; and
comparing the results of said analysis to identify one or more processes performed on the exposed portion of the first material in the reactor.

12. The method of claim 11 wherein the second material comprises a polymer having a sufficiently high melting point and chemical stability to be minimally affected by the exothermic reaction process;

13. The method of claim 11 wherein masking a portion of the first material with a second material comprises melting the second material and applying it to the surface of the first material; and wherein removing the second material from the first material comprises etching away the second material.

14. The method of claim 12 wherein analyzing the one or more properties of the first material at both a position that was masked and a position that was not masked comprises using one or more of atomic force microscopy, scanning electron microscopy, scanning tunneling electron microscopy, X-ray tunneling electron microscopy, X-ray photoelectron spectroscopy, and X-ray diffraction.

15. The method of claim 12 wherein the exothermic reactor is a dry cell reactor and the first material is plated on an interior part of the dry cell reactor.

16. The method of claim 12 wherein the exothermic reactor is a wet cell reactor and the first material is plated on an electrode of the wet cell reactor.

17. The method of claim 11 wherein removing the second material from the first material comprises etching away the second material.

18. The method of claim 11 wherein the first material is a transition metal that has a capacity for loading and storing hydrogen.
